(19) United States
(12) Patent Application Publication
(10) Pub. No.: US 2025/0220794 A1
(43) Pub. Date: Jul. 3, 2025

(54) Power Adapter with Sensing Control Function for Lamp Load

(71) Applicant: Chen Sheng Yang, Kaohsiung (TW)

(72) Inventor: Chen Sheng Yang, Kaohsiung (TW)

(21) Appl. No.: 19/052,038

(22) Filed: Feb. 12, 2025

Related U.S. Application Data
(63) Continuation-in-part of application No. 17/577,683, filed on Jan. 18, 2022.

(51) Int. Cl. H05B 47/17; F21S 4/10; F21V 23/04; F21Y 115/10; H01R 31/06

(52) U.S. Cl. CPC H05B 47/17; F21V 23/0485; H01R 31/065; F21S 4/10; F21Y 2115/10

(57) ABSTRACT

A power adapter with a sensing control function for a lamp load includes a plug case, a pin set, and a circuit board. The plug case has an exterior surface having an operation area. The pin set is mounted on the plug case. The circuit module is mounted in the plug case, is electrically connected to the pin set, and has a sensor board including a sensing conductor and a controller electrically connected to the sensing conductor. A position of the sensing conductor corresponds to a position of the operation area of the exterior surface of the plug case.

### CROSS REFERENCE OF RELATED APPLICATION

This application is a Continuation-In-Part application that claims the benefit of priority under 35U.S.C. § 120 to a non-provisional application, application Ser. No. 17/577,683, filed Jan. 18, 2022, which is incorporated herewith by reference in its entirety.

### BACKGROUND OF THE PRESENT INVENTION

### Field of Invention

The present invention relates generally to a power adapter, and mor particularly to a power adapter with a sensing control function for a lamp load, wherein the physical deformable soft touch button is eliminated on the plug case of the power adapter and an operation area is integrally defined on the plug case to function as a solid touch pad for controlling a circuit module sealedly contained in the plug case of the power adapter.

### Description of Related Arts

LED (Light Emitting Diode) string light is a common device for decoration. In order to turn on and switch the light modes of the LED string light, with reference to FIG. 13, conventional devices such as a power adapter 60. Output of the control box 61 is electrically connected to the LED string light.

For example, the power adapter 60 may be inserted into a power socket on a wall, and converted an input power, such as a DC (Direct Current) power or an AC (Alternating Current) power, from the power socket to a suitable DC power to supply power to the control box 61 and the LED string light. The control box 61 has a physical button 610. When the physical button 610 is pressed by a user, the control box 61 can turn on/off the LED string light or switch lighting modes of the LED string light. It is to be understood that any one of the power adapter 60 and the control box 61 should be indispensable. Otherwise, neither the power adapter 60 nor the control box 61 can control the LED string light alone.

However, the power adapter 60 and the control box 61 are two separate devices and thus are individually manufactured. The material and production cost for their cases and printed circuit boards (PCBs) are hardly reduced. Besides, the control box 61 has a poor waterproof capability. For example, the case of the control box 61 should have a hole, such that the physical button 610 can be mounted in the hole. When the user accidentally spills a glass of water over on the control box 61, the water will infiltrate the control box 61 via the hole and damage the circuit board in the control box 61. In addition, the physical button 610 may include a metal dome that will rust easily to be damaged when in contact with water and oxygen. Hence, the service life of the physical button 610 is not that long.

U.S. Pat. No. 8,337,250, owned by the inventor of the present invention, discloses an electric plug which includes a printed circuit board received in casing and two contacting blades mounted in the casing, wherein each contacting lade has a first end protruding and extending out from the front end of the casing and a second end disposed in cavity in the casing and electrically connected with the printed circuit board through a clamper, so as to allow the printed circuit board to be concealed in the casing in a sealed manner to mitigate and obviate the shortcomings of the conventional electric plug that generates heat during operation and transmits heat to the conducting wires between the contacting blades and the printed circuit board, causing the conducting wires to be easily melted after a long period of use.

Referring to FIG. 13 and FIG. 14, the power adapter 60 and the control box 61 as shown in FIG. 13 are integrated in the electric plug of the '250 patent to form a power adapter for a lamp load, such as a LED light string P200, which comprises a soft press pad P101, mounted externally on a case P100, acts as a user interface for activating or switching functions within the power adapter, such that when pressed, it deforms slightly and transmits force to an internal function button P102 located inside the case P100. The function button P102 inside can be a tactile switch, momentary switch, or a toggle switch that remains in position until pressed again and registers the press and changes modes of the lamp load P200 (e.g., turning on/off or cycling through settings).

The soft press pad P101, which is a flexible pad made from a flexible material like silicone or rubber and mounted in a pad hole P103 formed in a case wall of the case P100, is designed for ease of pressing while protecting internal components and controlling essential operations such as power regulation, mode selection, or reset functionality. The internal function button P102 is a mechanical switch that responds to the pressure exerted by the soft press pad P101.

Similarly, when the user accidentally spills a glass of water over on the case P100, the water will infiltrate the case via the pad hole P103 and damage the circuit board P104 in the case P100. Even moisture can seep through the gap between the soft press pad P101 and the case P100 and reach the function button P102 and other internal electrical components on the circuit board P104. Thus, the physical button P102 that includes metal dome will rust easily to be damaged when in contact with water and oxygen. Hence, the service life of the function button P102 is not that long. In addition, water exposure can cause short circuits, leading to malfunction or permanent damage.

It is well known that electrical contacts and the electrical components of the circuit board P104 inside the case P100 can corrode when exposed to humidity. This reduces the lifespan and reliability of the power adapter. Dirt, dust, and debris accumulated inside the case 101 through the gap between the soft press pad P101 and the case P100 can block or interfere with the function button P102, reducing its responsiveness. Further, if water or dirt intrusion causes the function button P102 to become stuck or unresponsive, it could lead to continuous activation or failure of the function button P102. Especially, the power adapter is used to convert AC input power to DC output power for lamp load, the 110V or 220V high AC voltage could pose an electric shock hazard or even a fire risk if internal electrical components short-circuit.

### SUMMARY OF THE PRESENT INVENTION

An objective of the present invention is to provide a power adapter with a sensing control function for a lamp load to overcome the defects of the conventional power adapter and the control box.

Another objective of the present invention is to provide a power adapter for lamp load which eliminates the conventional soft press pad and the function button and provides a sensing control function that is accomplished by a solid touch pad formed on the plug case of the power adapter. In other words, no physical button is provided in the power adapter of the present invention, allowing the plug case of the power adapter to remain an integral solid casing to ensure a waterproof ability and a fully sealed mechanism of the plug case to sealingly contain the electric components of the power adapter in the plug case.

Another objective of the present invention is to provide a power adapter for lamp load without any physical soft press pad thereon and function button therein, wherein an operation area is defined on an exterior surface of the plug case to function as the solid touch pad and equipped with a sensing unit, such as resistive or capacitive touch sensor, arranged in the plug case correspondingly.

Another objective of the present invention is to provide a power adapter with sensing control function for lamp load, which comprises a solid sensing mechanism, allowing the plug case do not provide any physical button, switch, press pad, and etc. for controlling function of the lamp load and remaining an integral casing to contain all electric components of the power adapter sealingly in the plug case, wherein such solid touch pad (the operation area defined on the exterior surface of the plug case) is made from rigid materials like metal or hard plastic, which are more resistant to wear and tear. It is ideal for applications requiring long-term use or exposed to environmental factors like dust, moisture or impact, such as the LED light string, especially being used outdoor. The exterior surface, including the operation area, of the plug case is easy to clean and maintain and less likely to trap dirt, grease, or liquids compared to the soft material of the conventional soft touch pad.

Another objective of the present invention is to provide a power adapter with sensing control function for lamp load, wherein the solid sensing mechanism reply on capacitance changes and maintain consistent sensitivity across the entire operation area of the plug case, while minimal physical interference.

Another objective of the present invention is to provide a power adapter with sensing control function for lamp load, wherein the rigid material of the whole plug case can better support stable electric field generation, ensuring precise capacitive touch detection and the thickness and rigidity also reduce noise or false triggers caused by environmental factors like vibration.

Another objective of the present invention is to provide a power adapter with sensing control function for lamp load, wherein no moving part is used for function control thereof and the operation area as the solid touch pad does not wear out or break due to mechanical stress and does not lose responsiveness over time, unlike the conventional soft press pad that may degrade over time.

Another objective of the present invention is to provide a power adapter with sensing control function for lamp load, which comprises a solid sensing mechanism, allowing the plug case do not provide any physical button, switch, press pad, and etc. for controlling function of the lamp load and remaining an integral casing to contain all electric components of the power adapter sealingly in the plug case, wherein the solid sensing mechanism registers input almost instantly through capacitance sensing, requiring minimal physical effort, unlike the conventional soft press pad has a slight delay due t the need for physical actuation.

Another objective of the present invention is to provide a power adapter with sensing control function for lamp load, which solid sensing mechanism allows the user to control the function of the lamp load simply by the lightest touch or even can support proximity sensing (detecting touches even before physical contact), while approaching the operation area within a predetermined distance with a finger of the user. In other words, the operation area can respond to a light touch or even a finger approach within the predetermined distance.

Another objective of the present invention is to provide a power adapter with sensing control function for lamp load, which solid sensing mechanism can detect multiple points of contact, swipes, or gestures, enabling more complex functionality that a physical function button or soft press pad cannot achieve. In addition, the solid sensing mechanism can work with microcontrollers or sensing ICs that allow customization, such as short touch and long touch for different functions and sensitivity adjustment.

Another objective of the present invention is to provide a power adapter with sensing control function for lamp load, which can avoid the drawbacks of the conventional soft press pad and physical button, such as suffering from issues like stuck buttons, spring failures, or less of tactile feedback over time.

Another objective of the present invention is to provide a power adapter with sensing control function for lamp load, wherein the sensing operation is completely silent for no moving part is equipped.

Another objective of the present invention is to provide a power adapter with sensing control function for lamp load, which is more suited for waterproof designs due to its flat, rigid and seamless exterior surface of the plug case by eliminating mechanical movement for the function control, wherein no gaps or openings is needed in the plug case. This enables the power adapter to remain fully enclosed, preventing water ingress.

Additional advantages and features of the invention will become apparent from the description which follows, and may be realized by means of the instrumentalities and combinations particular point out in the appended claims.

According to the present invention, the foregoing and other objects and advantages are attained by a power adapter with a sensing control function for a lamp load, which comprises a plug case, a pin set, and a circuit board. The plug case has an exterior surface having an operation area. The pin set is mounted on the plug case. The circuit module is mounted in the plug case, is electrically connected to the pin set, and has a sensor board comprising a sensing conductor and a controller electrically connected to the sensing conductor. A position of the sensing conductor corresponds to a position of the operation area of the exterior surface of the plug case.

The power adapter of the present invention has the single plug case, and the sensor board is mounted in the plug case. In other words, the sensor board is not separated from the plug case. Therefore, the configuration of the plug case and the circuit module is much simplifier than that of the conventional power adapter and the control box. The material and production cost for the power adapter of the present invention will be less than those of the conventional power adapter and the control box.

Besides, the plug case of the present invention does not have an opening for mounting a physical button, so as to have a better waterproof capability than the conventional control box.

In addition, the sensor board of the present invention can sense the user's operation while the user's finger approaches the operation area of the plug case. The present invention does not adopt the physical button as the conventional control box. Hence, the present invention may have much longer service life than the conventional control box.

In conclusion, the defects of the conventional power adapter and the control box are overcome.

In accordance with an aspect of the invention, the present invention provides a power adapter with a sensing control function for a lamp load, the power adapter comprising:
a plug case having an exterior surface having an operation area;
a pin set mounted on the plug case; and
a circuit module mounted in the plug case, electrically connected to the pin set, and having a sensor board comprising:
a sensing conductor, wherein a position of the sensing conductor corresponds to a position of the operation area of the exterior surface of the plug case; and
a controller electrically connected to the sensing conductor.

In one embodiment, the power adapter further comprises an indicator formed on or around the operation area.

In one embodiment, the pin set is mounted on a side wall of the plug case.

In one embodiment, the pin set is mounted on an end wall of the plug case.

In one embodiment, the sensing conductor is a metal foil.

In one embodiment, a center of the sensing conductor is aligned with a center of the operation area.

In one embodiment, the operation area is a concave portion in the exterior surface of the plug case.

In one embodiment, the operation area is a flat plane in the exterior surface of the plug case.

In one embodiment, the sensing conductor contacts an inner surface of the plug case.

In one embodiment, the inner surface of the plug case has a protrusion having a bottom surface that contacts the sensing conductor.

In one embodiment, the sensing conductor is separate from an inner surface of the plug case.

In one embodiment, the plug case has a connector having a thread portion; the pin set is mounted on a side wall of the plug case; and the side wall is adjacent to the connector.

In one embodiment, the plug case has a connector having a thread portion; the pin set is mounted on an end wall of the plug case; and the end wall is opposite to the connector.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a side view of a power adapter according to a preferred embodiment of the present invention.

FIG. 2 is a top view of the power adapter according to the preferred embodiment of the present invention.

FIG. 3 is a top view of the power adapter according to an alternative mode of the above preferred embodiment of the present invention.

FIG. 4 is a block diagram of a lighting apparatus, illustrating a circuit module of the power adapter, according to the preferred embodiment of the present invention.

FIG. 5 is a partial cross-sectional view of the power adapter according to the above preferred embodiment of the present invention.

FIG. 6 is a partial cross-sectional view of the power adapter according to an alternative of the above preferred embodiment of the present invention.

FIG. 7 is a schematic view of the power adapter according to the above preferred embodiment of the present invention, showing a user's finger is put on an operation area of a plug case of the power adapter of the present invention.

FIG. 8 is a schematic view of a practical embodiment of the power adaptor according to the above preferred embodiment of the present invention.

FIG. 9 is an exploded schematic view of the practical embodiment of the power adaptor according to the above preferred embodiment of the present invention.

FIG. 10 is an exploded schematic view of the circuit board and the plug case body of the practical embodiment of the power adaptor according to the above preferred embodiment of the present invention.

FIG. 11 is a circuit diagram of the circuit module of the power adapter according to the preferred embodiment of the present invention.

FIG. 12 is a schematic view illustrating a conventional power adapter and a control box for an LED string light.

FIG. 13 is an exploded schematic view illustrating a conventional power adapter and LED light string connected therewith.

FIG. 14 is another exploded schematic view illustrating the conventional power adapter and LED light string connected therewith.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art.

The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

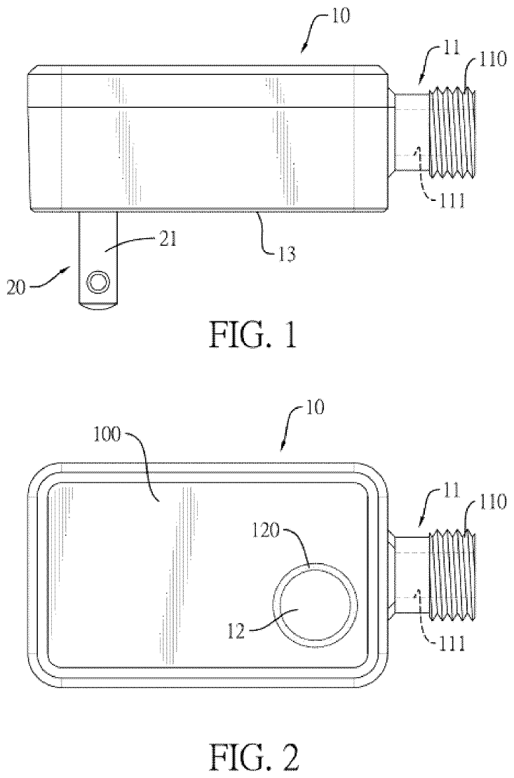

Referring to FIG. 1 to FIG. 7, according to a preferred embodiment of the present invention, a power adapter with a sensing control function for a lamp load is illustrated. In other words, the power adapter of the present invention is applied to the lamp load, such as an LED (light emitting diode) string light, an LED strip, an LED rope light, a lamp device, and so on. When receiving an input power, such as a DC (Direct Current) power or an AC (Alternating Current) power, the power adapter of the present invention will convert the input power to a suitable DC power and provide driving signals to the lamp load. As a result, the lamp load will be turned on according to the driving signals. The sensing control function is to switch lighting modes of the lamp load. For example, in general, the lighting modes may include a flashing mode, a brightness-gradual-changing mode, and a color-changing mode.

The power adapter according to the preferred embodiment of the present invention comprises a plug case 10, a pin set 20, and a circuit module 30.

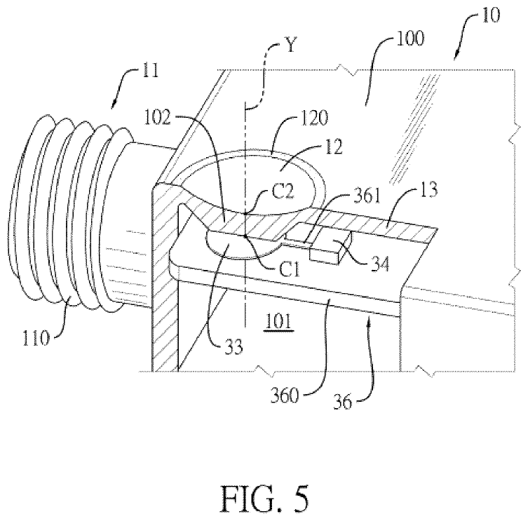

With reference to FIG. 1 and FIG. 2, the plug case 10 has an exterior surface 100. The plug case 10 is an electrical insulator, such as a plastic case. Besides, with reference to FIG. 5, the plug case 10 may have a mounting space 101 inside. As shown in FIG. 1 and FIG. 2, the plug case 10 has a connector 11. The connector 11 has a thread portion 110 and an opening 111. The opening 111 communicates with the mounting space 101 of the plug case 10. The exterior surface 100 of the plug case 10 has an operation area 12. In other words, the operation area 12 may be a part of the exterior surface 100 of the plug case 10. A user may put a finger on or above the operation area 12 to implement the sensing control function, which will be described as follows.

Besides, according to the preferred embodiment of the present invention, the power adapter may comprise an indicator 120 formed on or around the operation area 12. For example, the indicator 120 may be a printed pattern or a sticker. The indicator 120 is used to indicate the position of the operation area 12. Seeing the indicator 120, the user may know the position of the operation area 12 and put the finger on or above it.

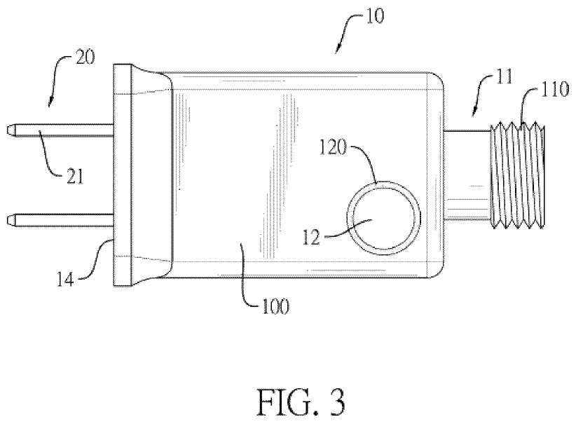

The pin set 20 is mounted on the plug case 10. For example, the pin set 20 may include multiple pins 21 to be inserted into a power socket on a wall. With reference to FIG. 1, the pin set 20 is mounted on a side wall 13 of the plug case 10, wherein the side wall 13 is adjacent to the connector 11. In an alternative mode of the preferred embodiment, as shown in FIG. 3, the pin set 20 may be mounted on an end wall 14 of the plug case 10, wherein the end wall 14 is opposite to the connector 11.

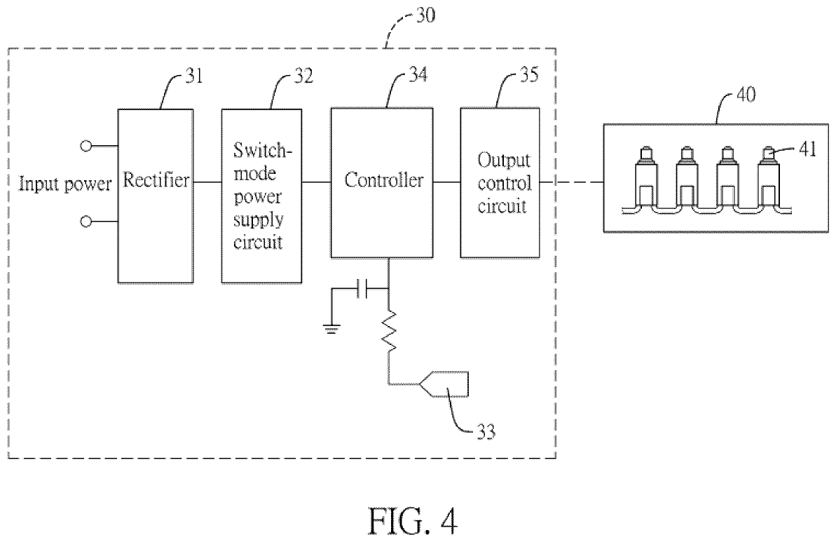

FIG. 4 depicts a circuit block diagram of the circuit module 30 and a lamp load 40 of a lighting apparatus. Please note that the working principle of the circuit module 30 is conventional. In brief, the circuit module 30 may comprise a rectifier 31, a switch-mode power supply circuit 32, a sensing conductor 33, a controller 34, and an output control circuit 35 electrically connected in series. Input of the rectifier 31 is electrically connected to the pin set 20. Output of the output control circuit 35 is electrically connected to the lamp load 40. The lamp load 40 shown in FIG. 4 includes multiple LEDs 41 connected in series. Wires connected between the circuit module 30 and the lamp load 40 may be mounted through the opening 111 of the connector 11. When the pin set 20 is inserted into the power socket on the wall, the rectifier 31 and the switch-mode power supply circuit 32 may convert an input power from the power socket to a suitable DC power. The controller 34 is electrically connected to the sensing conductor 33 and performs the sensing control function. The output control circuit 35 is controlled by the controller 34 to output driving signals to the lamp load 40 to turn on the lamp load 40.

The physical structure of the circuit module 30 may comprise circuit board(s) and electrical components, such as resistors, capacitors, inductors, integrated-circuit chips (IC chips), and so on, mounted on the circuit board(s). The circuit module 30 is mounted in the mounting space 101 of the plug case 10. As mentioned above, the circuit module 30 is electrically connected to the pin set 20 and the lamp load 40. In the preferred embodiment of the present invention, with reference to FIG. 5, the circuit module 30 may have a sensor board 36. The sensor board 36 comprises physical components of the sensing conductor 33 and the controller 34. The sensing conductor 33 and the controller 34 may be mounted on a printed circuit board (PCB) 360 of the circuit module 30. The controller 34 may be electrically connected to the sensing conductor 33 through a wire 361.

For example, the controller 34 may be a sensing IC chip. For example, the sensing conductor 33 may be a metal foil shaped as a filled circle, rectangle, triangle, or any other shapes. The metal foil may be a gold foil, a silver foil, a copper foil, an iron foil, an aluminum foil, and so on.

In the present invention, with reference to FIG. 5, the position of the sensing conductor 33 corresponds to the position of the operation area 12 of the exterior surface 100 of the plug case 10. Preferably, a center C1 of the sensing conductor 33 is aligned with a center C2 of the operation area 12 along a straight phantom line Y that is perpendicular to the side wall 13 of the plug case 10.

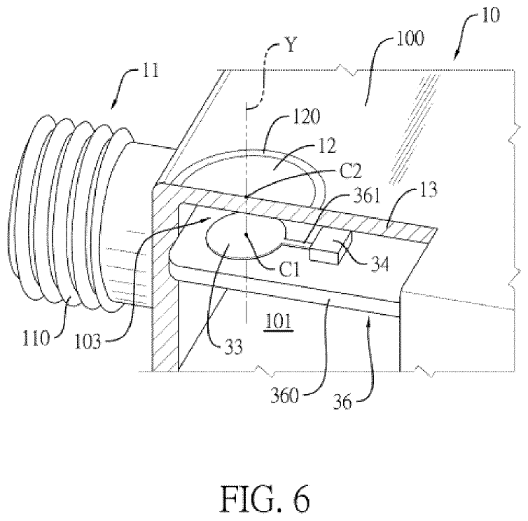

Regarding the operation area 12 of the plug case 10, according to the preferred embodiment as shown in FIG. 5, the operation area 12 may be a concave portion in the exterior surface 100 of the plug case 10. In an alternative mode of the preferred embodiment as shown in FIG. 6, the operation area 12 may be a flat plane on the exterior surface 100 of the plug case 10.

The sensing conductor 33 may contact an inner surface of the plug case 10. Or, there would be a gap 103 between the sensing conductor 33 and the inner surface of the plug case 10. With reference to the preferred embodiment shown in FIG. 5, the inner surface of the plug case 10 has a protrusion 102. The position of the protrusion 102 is between the operation area 12 and the sensing conductor 33. A bottom surface of the protrusion 102 contacts the surface of the sensing conductor 33. With reference to the alternative mode of the preferred embodiment shown in FIG. 6, the sensing conductor 33 is separate from the inner surface of the plug case 10, such that the gap 103 is formed between the sensing conductor 33 and the inner surface of the plug case 10.

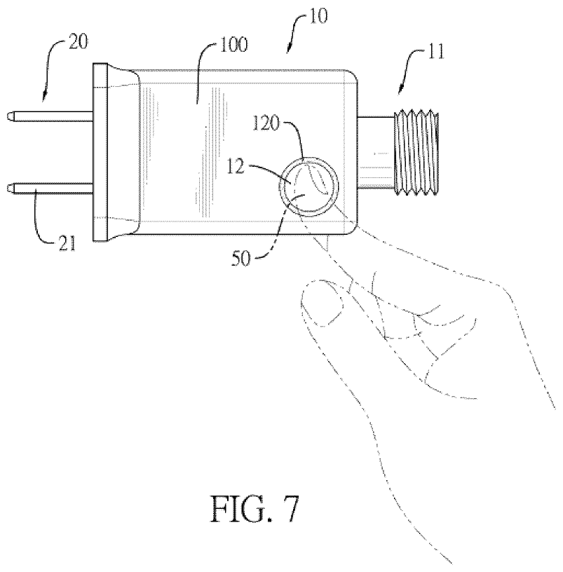

The working principle of the sensor board 36 is briefly introduced as follows. It is to be understood that the controller 34 may compute a resonant frequency according to a capacitance sensed from the sensing conductor 33. When the user does not put the finger on or above the operation area 12 of the plug case 10 yet, the controller 34 may determine that the resonant frequency is not varied. With reference to FIG. 7 and further to FIG. 5 and FIG. 6, when the user's finger 50 approaches the operation area 12 of the plug case 10, the side wall 13 of the plug case 10 is between the user's finger 50 and the sensing conductor 33. As a result, the capacitance sensed from the sensing conductor 33 will be affected by the user's finger 50 because the finger 50 is a conductor with electric charges. Then, the controller 34 may determine that the resonant frequency is varied due to the varied capacitance, so as to output the driving signal to the lamp load 40 via the output control circuit 35 to switch the lighting modes of the lamp load 40.

In the present invention, because the position of the sensing conductor 33 corresponds to the position of the operation area 12 of the plug case 10, the distance between the user's finger 50 and the sensing conductor 33 is minimized, and the electric charges on the finger 50 may affect the sensing conductor 33 directly, such that the sensing effect of the sensing conductor 33 will be maximized and optimized.

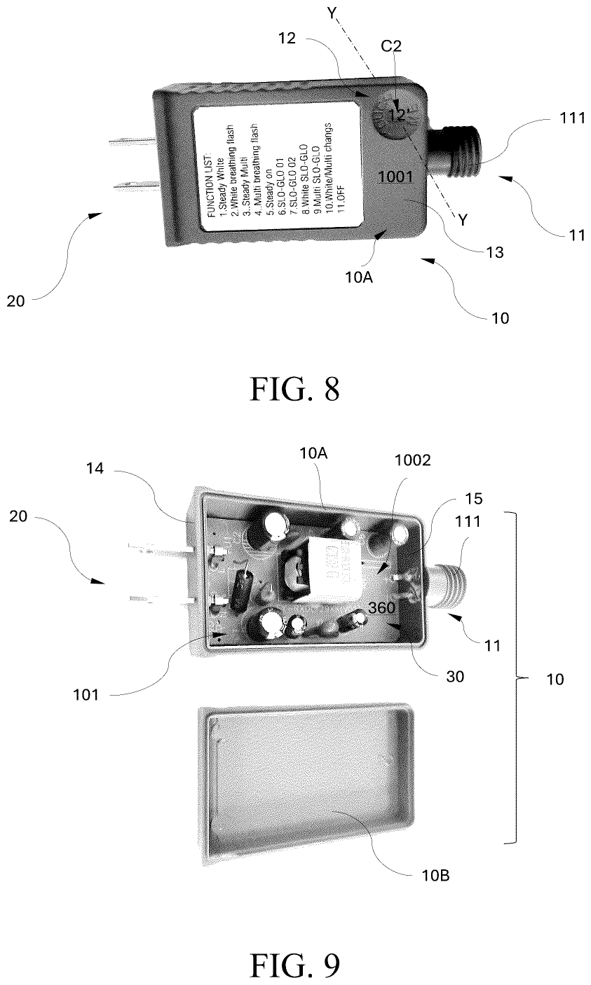

Referring to FIG. 8 to FIG. 10, a practical embodying example of the power adapter as shown in FIG. 1 to FIG. 7, for lamp load such as Christmas lights, LED light strings, and etc., according to the preferred embodiment of the present invention is illustrated, wherein the power adapter also comprises the plug case 10, the pin set 20 and the circuit module 30.

The plug case 10, having an exterior surface 100, is an electrical insulator made of insulating material such as a plastic case and comprises a case body 10A and a case body 10B configured to be sealingly engaged with each other to form the plug case 10 and define the mounting space 101 therein. The case body 10A has a front side wall surface 1001 on a front side wall 13 and a case opening 1002 on the other side for installing the circuit module 30 in the mounting space 101 and the case body 10B is shaped and sized to fittingly and sealingly cover the case opening 132 to form an integral and insulating solid case as the plug case 10.

The plug case 10 further comprises the connector 11 which has a thread portion 110 and the opening 111 communicating with the mounting space 101 of the plug case 10. The circuit module 30 is electrically connected with the lamp load 40 via the connector 11. Example of such electrically connection is illustrated in U.S. Pat. No. 8,376,788 of the inventor.

The pin set 20 is sealingly mounted on the plug case 10. For example, the pin set 20 may include multiple pins 21 to be inserted into the power socket on the wall. As shown in FIG. 8 to FIG. 10, the pin set 20 is mounted on the end wall 14 of the plug case 10 while the connector 11 is extended from an opposing end wall 15 of the plug case 10.

According to the preferred embodiment, the exterior surface 100 of the plug case 10 is defined as the surface on the six sides, including the front, rear, left, right, top, and bottom, of the plug case 10, including the front wall surface 132 of the case body 10A.

Referring to FIG. 4 and FIG. 9 of the drawings, the circuit module 30 comprises the rectifier 31, the switch-mode power supply circuit 32, the sensing conductor 33, the controller 34, and the output control circuit 35 electrically connected in series on the circuit board 360. Input of the rectifier 31 is electrically connected to the pin set 20. Output of the output control circuit 35 is electrically connected to the lamp load 40 via the connector 11. Example of the electrically connection between the pin set 20 and the rectifier 31 on the circuit board 360 is described in the U.S. Pat. No. 8,337,250 of the inventor.

The lamp load 40 as shown in FIG. 4 includes multiple LEDs 41 connected in series. Wires connected between the circuit module 30 and the lamp load 40 may be mounted through the opening 111 of the connector 11. As mentioned above, when the pin set 20 is inserted into a power socket on a wall, the rectifier 31 and the switch-mode power supply circuit 32 may convert an input power from the power socket to a suitable DC power. The controller 34 is electrically connected to the sensing conductor 33 and performs the sensing control function. The output control circuit 35 is controlled by the controller 34 to output driving signals to the lamp load 40 to turn on the lamp load 40. Examples of the circuit module 30 are illustrated in the U.S. Pat. Nos. 8,596,814 and 8,907,574 of the inventor.

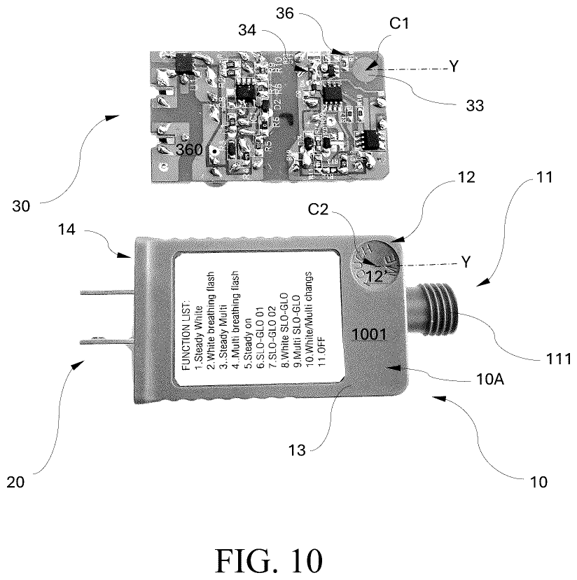

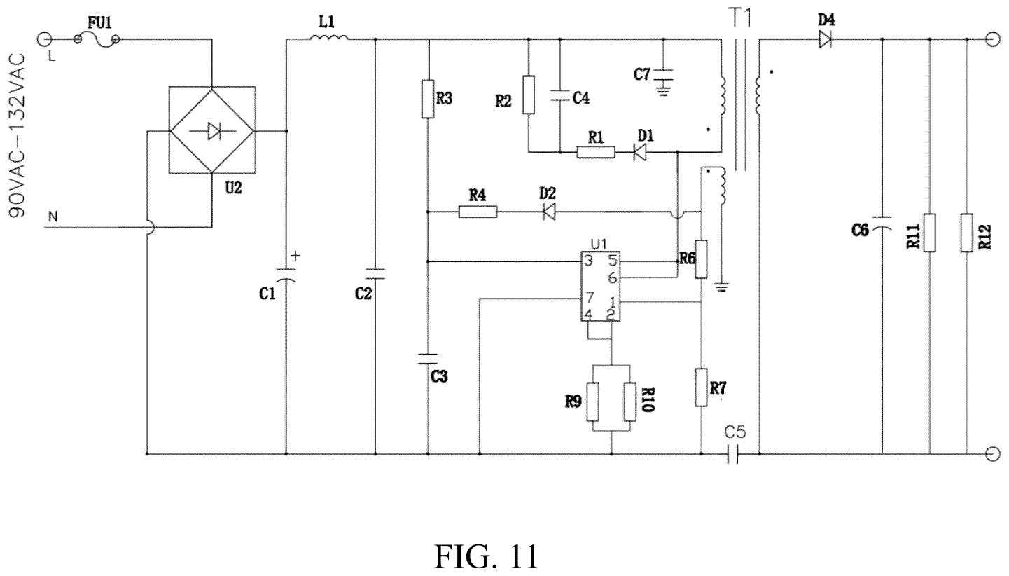

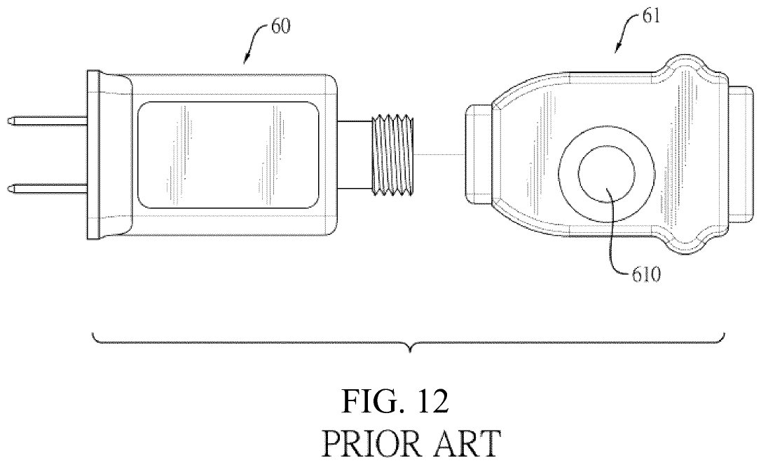

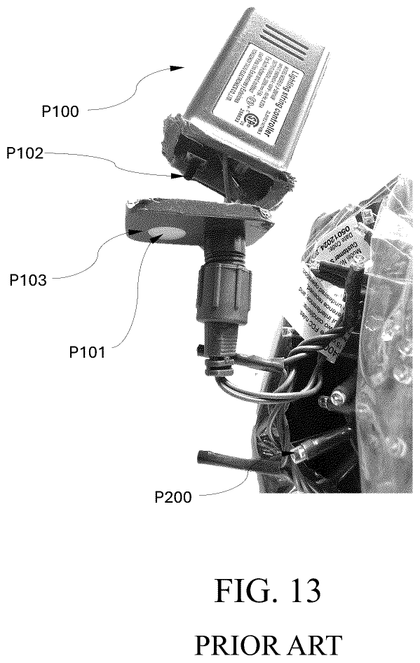

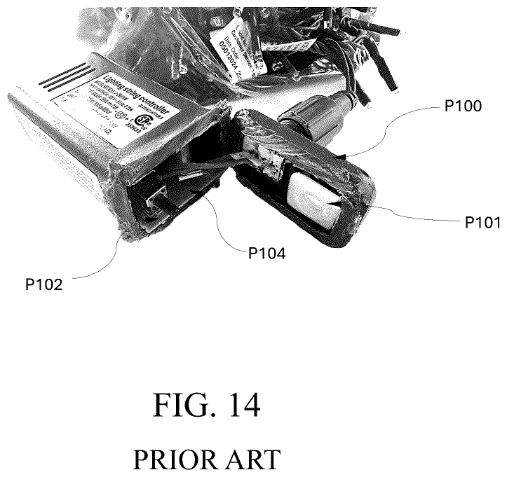

The physical structure of the circuit module 30 as shown in FIG. 9 and FIG. 10 may comprise electrical components, such as resistors, capacitors, inductors, integrated-circuit chips (IC chips), and so on, mounted on the circuit board 360. The circuit module 30 is mounted in the mounting space 101 of the plug case 10. As mentioned above, the circuit module 30 is electrically connected to the pin set 20 and the lamp load 40.

As shown in FIG. 8 and FIG. 10, the lighting modes of the lamp load 40 controlled by the circuit module 30 through the controller 34 include (1) steady white, (2) white breathing flash, (3) steady multiple colors, (4) multi-breathing flash, (5) steady on, (6) SLO-GLO (Slow Gradual Glowing effect-slowly fade in and out) 01 mode, (7) SLO-GLO 02 mode, (8) white SLO-GLO, (9) multiple colors SLO-GLO, (10) white/multiple colors changes, and (11) off.

As described above, the main objective of the present invention is to eliminate the physical button and the soft press pad of the conventional power adapter and to ensure the plug case 10 of the present invention being an integral solid casing that has no hole for mounting the physical button or the soft press pad. In other words, it is appreciated that the exterior surface 100 of the plug case 10 of the present invention provides a solid and rigid complete enclosure to seal and contain the circuit module 30 therein to insulate the circuit module 30 from outside and ensure a waterproof ability and a fully sealed mechanism.

According to the preferred embodiment of the present invention, the sensing control function provided by a sensing control arrangement is equipped with respect to the fully enclosing plug case 10. The sensing control arrangement comprises the sensing conductor 33 and the operation area 12. The operation area 12 is arranged as a specific portion designated on the exterior surface 100 and configured for a conductor of electric charges to approach to implement the sensing control function. As a safety arrangement according to the preferred embodiment, the operation area 12 is embodied as a circular area on a corner portion of the front wall surface 1001 adjacent to the connector 11 to form a solid touch pad 12′, which is a distal position from the pin set 20.

Referring to FIG. 4 to FIG. 10, the circuit module 30 comprises the sensor board 36 which can be a portion of the circuit board 360 extended to a position confronting the operation area 12 or an independent board positioned corresponding to the operation area 12 and electrically connecting to the circuit board 360. The sensor board 36 comprises physical components of the sensing conductor 33 and the controller 34. As shown in FIG. 10, the sensor board 36 is embodied as a corner portion of the circuit board 300 and the sensing conductor 33 and the controller 34 are mounted on the printed circuit board (PCB) 360 of the circuit module 30. The controller 34 may be electrically connected to the sensing conductor 33 through a wire 361 as illustrated in FIG. 5 and FIG. 6.

Referring to FIG. 11, the circuit module 30 comprises a 90V-132V AC input, a rectifier U2 which is a bridge rectifier for converting the AC input to DC voltage, filter capacitors C1, C2 for smoothing out the rectified DC voltage, a switch-mode power supply (SMPS) section, and an output and regulation section.

The switch-mode power supply section includes an inductor L1 and a transformer T1 configured for power conversion and isolation, a switching controller IC configured for regulating power conversion and controlling switching transistors, didoes D1, D2 configured for rectification in the switching circuit, resistors R3, R3 configured for setting operating conditions for the controller.

The output and regulation section includes an output diode D4 configured for converting high-frequency AC to DC, output capacitors C7, C4 configured for providing filtering to ensure a stable DC output, resistors R11, R12 configured as feedback elements for voltage regulation.

The circuit module 30 is configured to convert AC mains voltage to a regulated DC output (such as 29V for LED driver applications). The switch-mode power supply (SMPS) increases efficiency and reduces heat compared to linear power supplies. The transformer T1 provides isolation and voltage conversion, while the feedback loop (resistors and capacitors) ensures stable output.

According to the preferred embodiment, the controller 34 can be an IC chip and the sensing conductor 33 can be a metal foil shaped as a filled circle, rectangle, triangle, or any other shapes. The metal foil may be a gold foil, a silver foil, a copper foil, an iron foil, an aluminum foil, and so on. In order to ultimate the sensing control function, the position of the sensing conductor 33 is preferred to be aligned correspondingly and coaxially to the position of the operation area 12 of the exterior surface 100 of the plug case 10, wherein a center C1 of the sensing conductor 33 is aligned with a center C2 of the operation area 12 along a straight phantom line Y that is perpendicular to the front side wall of the plug case 10.

According to the preferred embodiment, the operation area 12 is embodied as a circular concave portion in the exterior surface 100 for ease to the user to simply touch the exterior surface 100 to locate such concave portion of the front side wall surface 1001 of the exterior surface 100 of the plug case 10 as the operation area 12, i.e. the solid touch pad 12′, even in a dark environment to control the lighting functions (1) to (11) of the lamp load 40. The concave portion is also easily to be observed by the user to locate and operate the solid touch pad 12′ by merely touching or even approaching his or her finger to the operation area 12 of the solid touch pad 12′, i.e. the concave surface of solid touch pad 12′. In the preferred embodiment, as shown in FIG. 8 and FIG. 10, the indicator 120 can be embodied as a marking “TOUCH” formed on the operation area 12 to remind the user that the control and operation of the solid touch pad 12′ is simply by touching without the need of any pressure nor pressing.

It is worth mentioning that the operation area 12 can be a flat plane on the exterior surface 100 of the plug case 10, wherein the indicator 120 can be embodied as a printed pattern or a sticker formed as a ring surrounding the operation area 12 to indicate the position of the operation area 12, as shown in FIG. 6. Certainly, the ring shape indicator 120 can further be provided around the concave operation area 12, referring to FIG. 5, FIG. 8 and FIG. 10.

Referring to FIG. 5, FIG. 8 and FIG. 10, the sensing conductor 33 is preferred to be arranged to contact an inner surface of the plug case 10, wherein the front side wall 13 has the protrusion 102 inwardly extended at the inner surface of the operation area 12 coaxially with the sensing conductor 33 until the bottom surface of the protrusion 102 contacts the surface of the sensing conductor 33.

It is appreciated that, according to the preferred embodiment, the sensing conductor 33 is not required to in contact with the inner surface of the operation area 12. In other words, as shown in FIG. 6, the sensing conductor 33 can also be separated from the inner surface of the operation area 12 of the plug case 10 to define the gap 103 between the sensing conductor 33 and the inner surface of the operation area 12 of the plug case 10, as long as the sensing conductor 33 can detect the user's finger touch or an approaching of a finger of the user within a predetermined distance on the operation area 12 of the solid touch pad 12′.

It is worth mentioning that the affixation of at least the sensor board 36 is preferred to be rigidly and firmly mounted in the mounting space 101 of the plug case 10 to provide a fix position of the sensing conductor 33 with respect to the operation area 12 to ensure the sensing control function of the present invention.

As described above, the working principle of the sensor board 36 is that the controller 34 is configured to compute a resonant frequency according to a capacitance sensed from the sensing conductor 33, such that when the user does not put the finger on or above the operation area 12 of the plug case 10 yet, the controller 34 may determine that the resonant frequency is not varied. Referring to FIG. 5 to FIG. 11, when the user's finger 50 approaches the operation area 12 of the plug case 10, the side wall 13 of the plug case 10 is between the user's finger 50 and the sensing conductor 33. As a result, the capacitance sensed from the sensing conductor 33 is affected by the user's finger 50 which is a conductor with electric charges near or touching on the operation area 12, and then, the controller 34 may determine that the resonant frequency is varied due to the varied capacitance, so as to output the driving signal to the lamp load 40 via the output control circuit 35 to switch the lighting modes (1) to (11) of the lamp load 40. According to the preferred embodiment of the present invention, because the position of the sensing conductor 33 corresponds to the position of the operation area 12 of the plug case 10, the distance between the user's finger 50 and the sensing conductor 33 is minimized, and the electric charges on the finger 50 is configured to affect the sensing conductor 33 directly, such that the sensing effect of the sensing conductor 33 is maximized and optimized.

More specifically, the operation area 12 of the solid touch pad 12′ acts as a capacitive sensor, such that when a user touches the operation area 12′ of the solid touch pad 12′, the finger of the user introduces a small change in capacitance. This happens because the human body acts as a conductive element, creating a slight alternation in the electrical field around the operation area 12 and the solid touch pad 12′.

The controller 34 (sensing IC chip) continuously monitors the capacitance at the operation area 12 and detects the change in capacitance caused by the user's finger touch or approaching and determines whether it exceeds a predetermined threshold value being set by the resistors or built into the controller 34. In other words, the capacitance changes due to the interaction of their body's electric field with the sensor board 36 and this change is detected by the sensing conductor 33 and the controller 34 of the sensor board 36, such as the sensing IC chip or a capacitor-resistor circuit. The controller 34 detects the change in capacitance and interprets it as a touch input and processes this signal to toggle or switch between lighting modes (1) to (11).

Depending on the touch input, the controller 34 adjusts the output to the lamp load 40 by controlling relays or switching circuits to switch between the lighting modes (1) to (11) based on the touch count or duration thereof.

To avoid false triggers, the controller 34 also filters out noise and stabilizes the input signal using a debouncing algorithm or circuitry. Once the controller 34 confirms a valid touch or approach event, it triggers a corresponding logic signal outputting to control the behavior of the lamp load 40 to, for example, adjust the brightness by using PWM (Pulse Width Modulation), switch between colors and enable or disable flashing or breathing effects. For example, each touch event causes the controller 34 to toggle or cycle through the lighting modes in a predefined sequence, such as the lighting modes (1) to (11).

The controller 34 can also be configured to use an internal counter to keep track of the current mode, to differentiate between a short touch and a long touch based on the touch duration, and to control the lamp load 40 through a MOSFET or relay, acting as an electronic switch to manage the current flow of the lamp load 40.

It is appreciated that the controller 34 may further configure to react immediately to the touch input, changing its lighting modes, save the last active mode, and restoring it when power is reapplied.

In view of above, the power adapter of the present invention has advantages including:

1. The power adapter of the present invention has the single plug case 10 and the sensor board 36 for implementing the sensing control function. The sensor board 36 is included in the plug case 10 and not separated from it. In other words, the configuration of the plug case 10 and the circuit module 30 is much simplifier than that of the conventional power adapter 60 and the control box 61. Hence, the material and production cost for the power adapter of the present invention will be less than those of the conventional power adapter 60 and the control box 61.

2. The conventional power adapter 60 and the control box 61 are separate devices, such that the staff have to manually assemble them to each other. In comparison, the circuit module 30 of the present invention is already included in the plug case 10. The present invention does not have more than two cases to be manually assembled. The above-mentioned conventional assembly issue should be resolved in the present invention. As described in the background of the invention, multiple drawbacks and hazards of the conventional integral power adapter caused by the physical function button and the soft press pad may result in electric shock hazard and even a fire risk. The advantages of the integration of the circuit module as power adapter for converting power voltage and the function switch without any physical function button or forming any hole on the plug case for mounting the function button can be achieved by implementing the sensing control function.

3. The power adapter of the present invention has the single plug case 10, so as to look more elegant than the conventional power adapter 60 and the control box 61.

4. The power adapter of the present invention has a better waterproof capability than the conventional control box 61 because the plug case 10 of the present invention does not have an opening for a physical button.

5. The sensor board 36 of the present invention can sense the user's operation while the user's finger approaches the operation area 12 of the plug case 10, even when the user's finger does not contact the operation area 12 yet. The present invention does not adopt the physical button 610 as the conventional control box 61. Hence, the present invention may have much longer service life than the conventional control box 61.

6. The plug case 10 is an electrical insulator. Hence, when the user operates the power adapter of the present invention, even when the user's finger contacts the operation area 12 of the plug case 10, the hazard of electric shock should be avoided. The entire plug case 10 is made of hard plastic which forms the electrical insulator between the user and the electric components of the circuit module 30. The operation of the function switch through approaching or touching the operation area 12 that the operation safety is guaranteed and the hazard of electric shock is completely avoided.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A lighting apparatus, comprising:
a lamp load; and
a power adapter with a sensing control function and without any physical button for switching light modes of the lamp load, which comprises:
a plug case, which is an electrical insulator without any opening or hole for any physical button, having an inner surface, an exterior surface and a mounting space defined therein, wherein the exterior surface has an operation area configured for a conductor of electric charges to approach to implement the sensing control function;
a pin set mounted on the plug case; and
a circuit module, mounted in the mounting space of the plug case and electrically connected to the pin set and the lamp load, comprising a sensor board which comprises:
a sensing conductor, wherein a position of the sensing conductor is arranged corresponding to a position of the operation area of the exterior surface of the plug case; and
a controller electrically connected to the sensing conductor.

2. The lighting apparatus, as recited in claim 1, wherein the controller is configured to compute a resonant frequency according to a capacitance sensed from the sensing conductor, wherein while the conductor of electric charges approaching the operation area, the operation area is between the conductor of electric charges and the sensing conductor, and the capacitance sensed by the sensing conductor is affected by the conductor of electric charges, wherein the controller is configured to determine a vary of the resonant frequency when the capacitance is varied, such that a driving signal is outputted by the circuit module to the lamp load to switch the lighting modes of the lamp load.

3. The lighting apparatus, as recited in claim 2, wherein a center of the sensing conductor is aligned with a center of the operation area coaxially.

4. The lighting apparatus, as recited in claim 3, wherein the plug case has a protrusion integrally protruded from an inner surface of the operation area, wherein the protrusion of the plug case is protruded from the inner surface and positioned between the operation area and the sensing conductor until a bottom surface of the protrusion contacts the sensing conductor to minimize a distance between the conductor of electric charges approaching the operation area and the sensing conductor so as to ensure the electric charges of the conductor of electric charges affecting the sensing conductor directly to maximize and optimize a sensing effect of the sensing conductor.

5. The lighting apparatus, as recited in claim 4, wherein the operation area is configured to allow the conductor of electric charges inputting thereon.

6. The lighting apparatus, as recited in claim 5, wherein the sensing conductor is a metal foil, having a predetermined shape selected from a group consisting of a filled circle, rectangle and triangle, and the metal foil is selected from a group consisting of a gold foil, a silver foil, a copper foil, an iron foil, and an aluminum foil.

7. The lighting apparatus, as recited in claim 4, wherein the plug case further has an indicator formed at the operation area for indicating a position of the operation area.

8. The lighting apparatus, as recited in claim 6, wherein the plug case further has an indicator formed at the operation area for indicating a position of the operation area.

9. The lighting apparatus, as recited in claim 4, wherein the circuit module comprises a rectifier, a switch-mode power supply circuit, a sensing conductor, a controller, and an output control circuit electrically connected in series, wherein an input of the rectifier is electrically connected to the pin set and an output of the output control circuit is configured for electrically connecting to the lamp load via the connector of the plug case.

10. The lighting apparatus, as recited in claim 6, wherein the circuit module comprises a rectifier, a switch-mode power supply circuit, a sensing conductor, a controller, and an output control circuit electrically connected in series, wherein an input of the rectifier is electrically connected to the pin set and an output of the output control circuit is configured for electrically connecting to the lamp load via the connector of the plug case.

11. The lighting apparatus, as recited in claim 8, wherein the circuit module comprises a rectifier, a switch-mode power supply circuit, a sensing conductor, a controller, and an output control circuit electrically connected in series, wherein an input of the rectifier is electrically connected to the pin set and an output of the output control circuit is configured for electrically connecting to the lamp load via the connector of the plug case.

12. The lighting apparatus, as recited in claim 3, wherein a gap is formed between the operation area and the sensing conductor that minimizes a distance between the conductor of electric charges approaching the operation area and the sensing conductor so as to ensure the electric charges of the conductor of electric charges affecting the sensing conductor directly to maximize and optimize a sensing effect of the sensing conductor.

13. The lighting apparatus, as recited in claim 12, wherein the operation area is configured to allow the conductor of electric charges putting thereon.

14. The lighting apparatus, as recited in claim 13, wherein the sensing conductor is a metal foil, having a predetermined shape selected from a group consisting of a filled circle, rectangle and triangle, and the metal foil is selected from a group consisting of a gold foil, a silver foil, a copper foil, an iron foil, and an aluminum foil.

15. The lighting apparatus, as recited in claim 12, wherein the plug case further has an indicator formed at the operation area for indicating a position of the operation area.

16. The lighting apparatus, as recited in claim 14, wherein the plug case further has an indicator formed at the operation area for indicating a position of the operation area.

17. The lighting apparatus, as recited in claim 12, wherein the circuit module comprises a rectifier, a switch-mode power supply circuit, a sensing conductor, a controller, and an output control circuit electrically connected in series, wherein an input of the rectifier is electrically connected to the pin set and an output of the output control circuit is configured for electrically connecting to the lamp load via the connector of the plug case.

18. The lighting apparatus, as recited in claim 14, wherein the circuit module comprises a rectifier, a switch-mode power supply circuit, a sensing conductor, a controller, and an output control circuit electrically connected in series, wherein an input of the rectifier is electrically connected to the pin set and an output of the output control circuit is configured for electrically connecting to the lamp load via the connector of the plug case.

19. The lighting apparatus, as recited in claim 16, wherein the circuit module comprises a rectifier, a switch-mode power supply circuit, a sensing conductor, a controller, and an output control circuit electrically connected in series, wherein an input of the rectifier is electrically connected to the pin set and an output of the output control circuit is configured for electrically connecting to the lamp load via the connector of the plug case.

20. The lighting apparatus, as recited in claim 18, wherein the circuit module comprises a rectifier, a switch-mode power supply circuit, a sensing conductor, a controller, and an output control circuit electrically connected in series, wherein an input of the rectifier is electrically connected to the pin set and an output of the output control circuit is configured for electrically connecting to the lamp load via the connector of the plug case.
